(19) United States
(12) Patent Application Publication
(10) Pub. No.: US 2026/0310110 A1
(43) Pub. Date: Oct. 8, 2026

(54) TONER, DEVELOPER, TONER STORAGE UNIT, IMAGE FORMING APPARATUS, AND IMAGE FORMING METHOD

(71) Applicants: Ayaka MORI, Shizuoka (JP); Yoshitaka YAMAUCHI, Shizuoka (JP); Masayuki ISHII, Shizuoka (JP); Hisashi NAKAJIMA, Shizuoka (JP); Shimpei MIYATA, Tokyo (JP); Kohtaroh OGINO, Shizuoka (JP)

(72) Inventors: Ayaka MORI, Shizuoka (JP); Yoshitaka YAMAUCHI, Shizuoka (JP); Masayuki ISHII, Shizuoka (JP); Hisashi NAKAJIMA, Shizuoka (JP); Shimpei MIYATA, Tokyo (JP); Kohtaroh OGINO, Shizuoka (JP)

(21) Appl. No.: 19/635,831

(22) Filed: Apr. 1, 2026

(30) Foreign Application Priority Data
Apr. 8, 2025 (JP) 2025-063596

(51) Int. Cl. G03G 9/087; G03G 21/18

(52) U.S. Cl. CPC G03G 9/08755; G03G 9/08708; G03G 9/08782; G03G 9/08797; G03G 21/1814

(57) ABSTRACT

A toner is provided that includes toner particles containing a polyester resin, an aromatic petroleum resin having a structure including styrene and α-methylstyrene and having a glass transition temperature of 80° C. or higher, and a release agent. The toner satisfies the following conditions A and B when cross sections of 100 toner particles of the toner are observed: Condition A: when S1 denotes a cross-sectional area of one toner particle and S2 denotes a total cross-sectional area of the release agent in the one toner particle, an average value of S2/S1 satisfies the following relational expression (1): 0.015<S2/S1<0.075 (1); and Condition B: 90 or more toner particles out of the 100 toner particles satisfy the condition A.

### CROSS-REFERENCE TO RELATED APPLICATION

This patent application is based on and claims priority pursuant to 35 U.S.C. § 119(a) to Japanese Patent Application No. 2025-063596, filed on Apr. 8, 2025, in the Japan Patent Office, the entire disclosure of which is hereby incorporated by reference herein.

### BACKGROUND

### Technical Field

The present disclosure relates to a toner, a developer, a toner storage unit, an image forming apparatus, and an image forming method.

### Related Art

In electrophotographic devices, electrostatic recording devices, and the like, an electric latent image or a magnetic latent image is visualized by a toner for developing an electrostatic latent image (also referred to as “toner” in the present disclosure). For example, in electrophotography, the electrostatic latent image is formed on a photoconductor, and thereafter, the electrostatic latent image is developed by using a toner to form a toner image. The toner image is usually transferred onto a recording medium such as paper and fixed by a method such as heating.

In recent years, there has been a growing demand for low-temperature fixation of toner to achieve energy savings by reducing the energy required for fixation. Furthermore, due to a demand for faster speeds and higher image quality in image forming apparatuses, coupled with the diversification of the purposes for which image forming apparatuses are used, there is an increasing demand for a toner that can be fixed at low temperatures. A known technique for fixing a toner at low temperatures is a technique in which an amorphous polyester resin and a crystalline polyester resin are used in combination.

### SUMMARY

Embodiments of the present disclosure provide a toner that includes toner particles containing a polyester resin, an aromatic petroleum resin having a structure including styrene and α-methylstyrene and having a glass transition temperature of 80° C. or higher, and a release agent. The toner satisfies the following conditions A and B when cross sections of 100 toner particles of the toner are observed:

Condition A: when S1 denotes a cross-sectional area of one toner particle and S2 denotes a total cross-sectional area of the release agent in the one toner particle, an average value of S2/S1 satisfies the following relational expression (1):

$$0.015 < S 2 / S 1 < 0.075 ; \qquad ( 1 )$$

Condition B: 90 or more toner particles out of the 100 toner particles satisfy the condition A.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic illustrative diagram of an image forming apparatus according to an embodiment of the present disclosure;

FIG. 2 is a schematic illustrative diagram of an image forming apparatus according to an embodiment of the present disclosure;

FIG. 3 is a schematic illustrative diagram of an image forming apparatus according to an embodiment of the present disclosure;

FIG. 4 is a schematic illustrative diagram of an image forming unit; and

FIG. 5 is a schematic configuration diagram of a process cartridge according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present disclosure, a toner is provided having excellent fixability at low temperatures and having both filming inhibition under a high temperature and humidity environment and hot offset resistance and heat-resistant storage stability during fixing.

The present disclosure will be described below in detail.

### (Toner)

A toner according to embodiments of the present disclosure includes a polyester resin, an aromatic petroleum resin, and a release agent, and optionally may include a colorant, an external additive, and other components.

Hereinafter, the polyester resin and the aromatic petroleum resin may be collectively referred to as a binder resin.

The toner according to embodiments of the present disclosure satisfies the following condition A when the cross sections of 100 toner particles of the toner are observed.

### (Condition A)

When S1 denotes the cross-sectional area of one toner particle and S2 denotes the total cross-sectional area of the release agent in the one toner particle, the average value of S2/S1 satisfies the following relational expression (1).

$$0.015 < S 2 / S 1 < 0.075 \qquad ( 1 )$$

The above S2/S1 represents, in a cross section of one toner particle, the area ratio of the total cross-sectional area of the release agent to the cross-sectional area of the toner particle. If S2/S1 is 0.075 or greater, the area ratio of the release agent in the toner particle is large, so that the release agent tends to bleed out to the toner surface layer, and undesired phenomena such as filming due to the release agent adhering to the photoconductor tend to occur. If S2/S1 is 0.015 or smaller, the area ratio of the release agent in the toner particle is small, so that the amount of the release agent bleeding during fixing at a high temperature is insufficient, and an offset image is likely to occur.

The toner according to embodiments of the present disclosure satisfies the following condition B when the cross sections of 100 toner particles are observed.

### (Condition B)

90 or more toner particles out of the 100 toner particles satisfy the condition A.

This index indicates how small the variation in release agent area ratio between toner particles is. If the number of toner particles satisfying the above condition A is less than 90, problems such as filming due to adhesion of release agent to the photoconductor and offset images during fixing at high temperatures are likely to occur due to toner particles not satisfying the condition A. It is also found that such a tendency is particularly pronounced in high-speed apparatuses.

It is noted that a specific method of measuring S2 and S1 will be described later in examples.

### <Binder Resin>

Examples of the polyester resin used in the present disclosure include, but are not limited to, polyester resins obtained by condensation polymerization of a generally known alcohol and an acid. Examples of the alcohol include, but are not limited to, diols such as polyethylene glycol, diethylene glycol, triethylene glycol, 1,2-propylene glycol, 1,3-propylene glycol, 1,4-propylene glycol, neopentyl glycol, and 1,4-butanediol; etherified bisphenols such as 1,4-bis(hydroxymethyl)cyclohexane, bisphenol A, hydrogenated bisphenol A, polyoxyethylenated bisphenol A, and polyoxypropylated bisphenol A; dihydric alcohol units obtained by substituting such alcohols with a saturated or unsaturated hydrocarbon group having 3 to 22 carbon atoms; other dihydric alcohol units; and polyhydric alcohol monomers of trihydric or higher such as sorbitol, 1,2,3,6-hexanetetrol, 1,4-sorbitan, pentaerythritol, dipentaerythritol, tripentaerythritol, saccharose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Examples of carboxylic acids used to obtain the polyester resin, include, but are not limited to, monocarboxylic acids such as palmitic acid, stearic acid, and oleic acid; maleic acid; fumaric acid; mesaconic acid; citraconic acid; terephthalic acid; cyclohexanedicarboxylic acid; succinic acid; adipic acid; sebacic acid; malonic acid; divalent organic acid monomers obtained by substituting such carboxylic acids with a saturated or unsaturated hydrocarbon group having 3 to 22 carbon atoms; anhydrides of these acids; lower alkyl esters of these acids; dimers of linoleic acid; and polyvalent carboxylic acid monomers of trivalent or higher such as 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, tetra(methylenecarboxyl)methane, 1,2,7,8-octanetetracarboxylic acid Empol trimer acid, and acid anhydride thereof.

The polyester resin preferably includes an amorphous polyester resin and a crystalline polyester resin.

The amorphous polyester resin is preferably obtained by polycondensation of a component including an aromatic alcohol component and/or an aromatic carboxylic acid component.

The crystalline polyester resin is preferably obtained by polycondensation of a fatty alcohol component and an aliphatic carboxylic acid component.

The toner preferably contains from 1 to 10 parts by mass of the crystalline polyester resin, and more preferably contains from 2 to 6 parts by mass, per 100 parts by mass of the toner.

### <Release Agent>

The release agent in the present disclosure is not limited and can be appropriately selected according to a purpose, examples of the release agent include, but are not limited to, waxes. Specific examples of waxes include, but are not limited to, natural waxes including plant-based waxes such as a carnauba wax, a cotton wax, a wood wax, and a rice wax; animal-based waxes such as beeswax and lanolin; mineral-based waxes such as ozokerite and ceresin; and petroleum waxes such as paraffin, microcrystalline wax, and petrolatum.

In addition to such natural waxes, examples of waxes may include, but are not limited to, synthetic waxes including synthetic hydrocarbon waxes such as a Fischer-Tropsch wax, polyethylene, and polypropylene; esters, ketones, and ethers.

Further, examples of waxes to be used may include, but are not limited to, fatty acid amide compounds such as 12-hydroxystearamide, stearamide, phthalimide anhydride, and chlorinated hydrocarbons; homopolymers or copolymers of polyacrylates such as poly-n-stearyl methacrylate and poly-n-lauryl methacrylate, which are crystalline polymer resins having low molecular weight (for example, n-stearyl acrylate-ethyl methacrylate copolymer); and crystalline polymers having long alkyl groups in a side chain.

Among such waxes, hydrocarbon waxes such as a paraffin wax, a microcrystalline wax, a Fischer-Tropsch wax, a polyethylene wax, and a polypropylene wax are preferred because such waxes can inhibit occurrence of filming.

A preferable example of the hydrocarbon waxes includes a Fischer-Tropsch wax. An example of the Fischer-Tropsch wax may include FNP-0090 (manufactured by NIPPON SEIRO CO., LTD.).

The hydrocarbon waxes have low compatibility with common polyester resins, so that the hydrocarbon waxes tend to bleed out onto the surface during fixing, provide high release properties, and may ensure high gloss and high fixability at low temperatures.

The melting point of the release agent is not limited and can be appropriately selected according to a purpose, and the melting point is preferably 80° C. or higher and 100° C. or lower. If the melting point is lower than 80° C., the heat-resistant storage stability deteriorates, and if the melting point is higher than 100° C., the fixability at low temperatures deteriorates.

The content of the release agent is not limited and can be appropriately selected according to a purpose, but is preferably 2 parts by mass or more and 6 parts by mass or less, and more preferably 3 parts by mass or more and 5 parts by mass or less, per 100 parts by mass of the toner. If the content is less than 2 parts by mass, bleeding to the surface during fixing is insufficient, the release property deteriorates, and the fixability at low temperatures and high-temperature offset resistance decrease. If the content is more than 6 parts by mass, the amount of the release agent precipitated on the toner surface increases, the storage stability and the fluidity of the toner deteriorate, the filming property on the electrostatic latent image carrier or the like deteriorates, and the transportability of the transfer residual toner deteriorates.

### <Aromatic Petroleum Resin>

The toner according to embodiments of the present disclosure contains an aromatic petroleum resin. The toner containing the aromatic petroleum resin improves the pulverization properties of the toner and also improves the heat resistance while maintaining the fixability at low temperatures.

The aromatic petroleum resin is a resin synthesized by using, as a raw material, styrene, vinyltoluene, indene, and the like, which are C9 fractions of petroleum. In particular, styrene-based copolymers including styrene or α-methylstyrene are preferred.

The styrene-based copolymers are not limited, and examples thereof include, but are not limited to, polymers of styrene such as polystyrene, poly-p-styrene, and polyvinyltoluene and polymers of substituted products thereof, and styrene-based copolymers such as a styrene-α-methylstyrene copolymer, a styrene-p-chlorostyrene copolymer, a styrene-propylene copolymer, a styrene-vinyltoluene copolymer, a styrene-methyl acrylate copolymer, a styrene-ethyl acrylate copolymer, a styrene-butyl acrylate copolymer, a styrene-methyl methacrylate copolymer, a styrene-ethyl methacrylate copolymer, a styrene-butyl methacrylate copolymer, a styrene-α-methyl chloromethacrylate copolymer, a styrene-acrylonitrile copolymer, a styrene-vinyl methyl ether copolymer, a styrene-vinyl methyl ketone copolymer, a styrene-butadiene copolymer, a styrene-isoprene copolymer, a styrene-maleic acid copolymer, and a styrene-maleic acid ester copolymer. The toner particularly preferably contains the styrene-α-methylstyrene copolymer among such copolymers.

The glass transition temperature of the aromatic petroleum resin used in the present disclosure is 80° C. or higher and preferably 80° C. or higher and 90° C. or lower.

The molecular weight (Mw) of the aromatic petroleum resin is preferably 2,000 to 4,500, more preferably 2,100 to 4,100, and further preferably 2,500 to 3,800.

The content of the aromatic petroleum resin is preferably from 1 to 10 parts by mass, and further preferably from 3 to 7 parts by mass, per 100 parts by mass of the toner.

The glass transition point (Tg) in the present disclosure is obtained as a temperature of the intersection of an extension line of the baseline below the maximum peak temperature of the endothermic of a sample and a tangent line indicating the maximum slope from a rising portion of the peak to the peak apex by using a differential scanning calorimeter (manufactured by Seiko Instruments Inc., DSC210). 0.01 g to 0.02 g of the sample was weighed into an aluminum pan, heated to 150° C., and cooled at a cooling rate of 10° C./min to 20° C. from that temperature. The resultant sample was then heated at a heating rate of 10° C./min.

### <Colorant>

The colorant is not limited and can be appropriately selected according to a purpose. Examples of the colorant include, but are not limited to, carbon black, nigrosin dye, iron black, Naphthol Yellow S, Hansa Yellow (10G, 5G, G), Cadmium Yellow, yellow iron oxide, ocher, chrome yellow, titanium yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, Anthrazan Yellow BGL, Isoindolinone Yellow, red iron oxide, red lead, lead vermilion, Cadmium Red, Cadmium-Mercury Red, antimony vermilion, Permanent Red 4R, Para Red, Faise Red, Parachlor Orthonitroaniline Red, Lithol Fast Scarlet G, Brilliant Fast Scarlet, Brilliant Carmine B S, Permanent Red (F2R, F4R, FRL, FRLL, F4RH), Fast Scarlet V D, Belkan Fast Rubin B, Brilliant Scarlet G, Lithol Rubine G X, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red, Polyazole Red, Chrome Vermilion, Benzidine Orange, Perinone Orange, Oil Orange, Cobalt Blue, Cerulean Blue, Alkali Blue Lake, Peacock Blue Lake, Victoria Blue Lake, metal-free Phthalocyanine Blue, Phthalocyanine Blue, Fast Sky Blue, Indanthrene Blue (RS, BC), indigo, ultramarine blue, Prussian blue, Anthraquinone Blue, Fast Violet B, Methyl Violet Lake, cobalt violet, manganese violet, Dioxane Violet, Anthraquinone Violet, Chrome Green, Zinc Green, chromium oxide, pyridian, Emerald Green, Pigment Green B, Naphthol Green B, Green Gold, Acid Green Lake, Malachite Green Lake, Phthalocyanine Green, Anthraquinone Green, titanium oxide, zinc white, and lithobon.

These may be used alone or in combination of two or more types.

The content of the colorant is not limited and can be appropriately selected according to a purpose, but is preferably 1 parts by mass or more and 15 parts by mass or less, and more preferably 3 parts by mass or more and 10 parts by mass or less, per 100 parts by mass of the toner.

### <External Additive>

The external additive is not limited, can be appropriately selected according to a purpose, and examples thereof include a metal oxide, a silicon compound, and other fine particles.

Examples of the metal oxide include, but are not limited to, aluminum oxide, zinc oxide, cerium oxide, and oxidized zirconium. These may be used alone or in combination of two or more types.

Examples of the silicon compound include, but are not limited to, silicon oxide (silica), silicon carbide, silicon nitride, and silicon tetrachloride. Among such silicon compounds, silicon oxide (silica) is preferred. These may be used alone or in combination of two or more types.

Examples of the other fine particles include, but are not limited to, fatty acid metal salts (for example, zinc stearate and aluminum stearate) and fluoropolymers.

### <Other Components>

The other components are not limited and can be appropriately selected according to a purpose. Examples of the other components include, but are not limited to, a charge control agent, a fluidity improver, a cleaning improver, and a magnetic material.

### Charge Control Agent

The toner according to embodiments of the present disclosure may be either positively or negatively chargeable.

The charge control agent is not limited, can be appropriately selected according to a purpose, and examples thereof include, but are not limited to, nigrosine dyes, triphenylmethane dyes, metal complex dyes containing chromium, molybdate chelate pigments, rhodamine dyes, alkoxy amines, quaternary ammonium salts (including fluorine-modified quaternary ammonium salts), alkylamides, phosphorus alone or a phosphorus compound, tungsten alone or a tungsten compound, fluorine-based activators, metal salts of salicylic acid, and metal salts of derivatives of salicylic acid.

Specific examples of the charge control agent include, but are not limited to, BONTRON 03 which is a nigrosine dye, BONTRON P-51 which is a quaternary ammonium salt, BONTRON S-34 which is a metal-containing azo dye, E-82 which is an oxynaphthoic acid metal complex, E-84 which is a salicylic acid metal complex, and E-89 which is a phenol condensate (all manufactured by Orient Chemical Industries Co., Ltd.), TP-302 and TP-415 which are a quaternary ammonium salt molybdenum complex (both manufactured by Hodogaya Chemical Co., Ltd.), LRA-901, LR-147 which is a boron complex (manufactured by Japan Carlit Co., Ltd.), copper phthalocyanine, perylene, quinacridone, azo pigments, and other polymer compounds having functional groups such as sulfonic acid groups, carboxyl groups, and quaternary ammonium salts.

The content of the charge control agent is not limited and can be appropriately selected according to a purpose, but is preferably 0.1 parts by mass or more and 10 parts by mass or less, and more preferably 0.2 parts by mass or more and 5 parts by mass or less, per 100 parts by mass of the toner.

### Fluidity Improver

The fluidity improver is not limited and can be appropriately selected according to a purpose, as long as the fluidity improver can be used in a surface treatment to increase the hydrophobicity and prevent the deterioration of flowability characteristics and charging characteristics even under high humidity. Examples of the fluidity improver include, but are not limited to, silane coupling agents, silylating agents, silane coupling agents having a fluorinated alkyl group, organic titanate coupling agents, aluminum-based coupling agents, silicone oil, and modified silicone oil. The silica and titanium oxide used as the external additives are preferably surface-treated with such a flowability improver and used as hydrophobic silica and hydrophobic titanium oxide.

### Cleanability Improver

Examples of the cleanability improver include, but are not limited and can be appropriately selected according to a purpose, as long as the cleanability improver is added to the toner to remove a transferred developer remaining in the photoconductor or the primary transfer medium, and examples of the cleanability improver include fatty acid metal salts such as zinc stearate, calcium stearate, and stearic acid, and polymer fine particles prepared by soap-free emulsion polymerization such as polymethyl methacrylate fine particles and polystyrene fine particles. The polymer particles preferably have a relatively narrow particle size distribution, and the volume average particle diameter thereof is suitably from 0.01 μm to 1 μm.

### Magnetic Material

The toner according to embodiments of the present disclosure may be a magnetic toner containing a magnetic material, or a non-magnetic toner containing no magnetic material. The magnetic material is not limited and can be appropriately selected according to a purpose. Examples of the magnetic material include, but are not limited to, iron powder, magnetite, and ferrite. Among such magnetic materials, a white magnetic material is preferred in terms of color tone.

### <Developer>

The toner according to embodiments of the present disclosure can be used as a developer. The developer may be any one of a one-component developer and a two-component developer. If the developer is the two-component developer, the developer includes a carrier and the toner according to embodiments of the present disclosure.

The carrier is not limited and can be appropriately selected according to a purpose. However, the carrier preferably includes a core material and a resin layer covering the core material.

The material of the core material is not limited and can be appropriately selected according to a purpose. Preferred examples of the material include, but are not limited to, manganese-strontium (Mn—Sr)-based materials and manganese-magnesium (Mn—Mg)-based materials of 50 emu/g or more and 90 emu/g or less, and highly magnetized materials such as iron powder (100 emu/g or more), magnetite (75 emu/g or more and 120 emu/g or less) to ensure image density. Preferred examples of material of the core material include, but are not limited to, weakly magnetized materials such as copper-zinc (Cu—Zn)-based materials (30 emu/g or more and 80 emu/g or less), which can weaken the contact between the toner and the photoconductor when the toner is in a bristling state and thus, are advantageous for high image quality.

These may be used alone or in combination of two or more types.

The volume average particle diameter of the core material is preferably 25 μm or more and 200 μm or less.

The material of the resin layer is not limited and can be appropriately selected according to a purpose. Examples of the material of the resin layer include, but are not limited to, an amino resin, a polyvinyl resin, a polystyrene resin, a halogenated olefin resin, a polyester resin, a polycarbonate resin, a polyethylene resin, a polyvinyl fluoride resin, a polyvinylidene fluoride resin, a polytrifluoroethylene resin, a polyhexafluoropropylene resin, a copolymer of vinylidene fluoride and an acrylic monomer, a copolymer of vinylidene fluoride and vinyl fluoride, a fluoro terpolymer such as a terpolymer of tetrafluoroethylene, vinylidene fluoride, and a non-fluorinated monomer, and a silicone resin.

These may be used alone or in combination of two or more types.

If the developer is the two-component developer, the mixing ratio of the toner and the carrier in the two-component developer (the mass ratio of the toner relative to the carrier) is preferably 2.0 mass % or more and 12.0 mass % or less, and more preferably 2.5 mass % or more and 10.0 mass % or less.

### (Method of Manufacturing Toner)

A method of manufacturing a toner according to embodiments of the present disclosure includes a step of producing toner base particles including a polyester resin and a styrene resin and may include optionally another step.

An addition amount of the styrene resin in the step of producing the toner base particles is preferably 5 parts by mass or more and 10 parts by mass or less when the total amount of the toner base particles is 100 parts by mass.

### <Step of Producing Toner Base Particles>

In the step for producing the toner base particles, the above-mentioned toner materials may be mixed, kneaded, pulverized, and classified to obtain toner base particles (colored particles) having a desired particle diameter. The toner base particles, inorganic particles, and the like as other components may be mixed optionally (another step).

Specifically, firstly, after the above components are mixed well by a mixer such as a Henschel mixer, constitutional materials are kneaded well by a continuous-type twin-screw extruder (for example, a KTK-type twin-screw extruder manufactured by Kobe Steel, Ltd., a TEM-type twin-screw extruder manufactured by Toshiba Machine Co., Ltd., a PCM-type twin-screw extruder manufactured by Ikegai Iron Works Co., Ltd., a KEX-type twin-screw extruder manufactured by Kurimoto Ltd.), and a continuous-type single-screw mixer (for example, a co-kneader manufactured by Buss AG, and a heat mixer such as a mixer manufactured by KCK Co.). In this case, a method for increasing the specific energy includes a method for reducing the amount of kneading treatment, or a method for lowering the set temperature of the kneader to knead a kneaded product in a high viscosity state.

Next, after cooling the kneaded product, the kneaded product is roughly pulverized using a hammer mill or the like, and further pulverized finely by a fine pulverizer using a jet airflow or a mechanical pulverizer, and then classified to a predetermined particle size by a classifier using a swirling airflow or a classifier using the Coanda effect. In classifying the kneaded product, a fine particle portion may be removed by using, for example, a cyclone, a decanter, centrifugal separation or the like.

After completing pulverizing and classifying the kneaded product, the pulverized material is classified in an airflow by centrifugal force or the like to produce a toner having a predetermined particle diameter.

The weight average particle size of the toner obtained by the method of manufacturing a toner is not limited and may be appropriately selected according to a purpose, but is preferably 4 μm or more and 10 μm or less, and more preferably 5 μm or more and 8 μm or less.

A method of measuring the weight average particle size is not limited and can be appropriately selected according to a purpose, but, for example, the weight average particle size can be measured using a measurement device of the toner particle diameter distribution by Coulter counter method. An example of the measurement device includes, but is not limited to, Coulter Multisizer 4e (manufactured by Beckman Coulter, Inc.).

### (Toner Storage Unit)

The toner storage unit according to embodiments of the present disclosure stores the toner according to embodiments of the present disclosure.

When the toner storage unit according to embodiments of the present disclosure is attached to an image forming apparatus to form an image, an image is formed by using the toner according to embodiments of the present disclosure. Therefore, an image excellent in fixability at low temperatures and heat-resistant storage stability can be obtained.

The toner storage unit according to embodiments of the present disclosure refers to a component that stores the toner according to embodiments of the present disclosure in a unit having a function of storing the toner according to embodiments of the present disclosure. Examples of the toner storage unit include, but are not limited to, a toner storage container, a developing device, and a process cartridge.

The toner storage container refers to a container that stores the toner.

The developing device refers to a device including unit used for storing and developing the toner.

The process cartridge includes at least an electrostatic latent image bearer that carries an electrostatic latent image, and a developing unit that develops the electrostatic latent image carried on the electrostatic latent image bearer by using the toner to form a visible image, and may optionally further include other units appropriately selected such as a charging unit, an exposure unit, a developing unit, a transfer unit, a cleaning unit, and a static elimination unit.

The developing unit includes at least a developer container that stores the toner or the developer according to embodiments of the present disclosure, and a developer bearer that carries and conveys the toner or the developer stored in the developer container, and may further include a layer thickness control member and the like to regulate the layer thickness of the toner to be carried.

The process cartridge may be provided to be attachable to and detachable from various types of electrophotographic apparatuses, facsimile devices, and printers, and is preferably provided to be attachable to and detachable from the image forming apparatus according to embodiments of the present disclosure described later.

### (Image Forming Method and Image Forming Apparatus)

The image forming apparatus according to embodiments of the present disclosure includes an electrostatic latent image bearer, an electrostatic latent image forming unit that forms an electrostatic latent image on the electrostatic latent image bearer, a developing unit that develops the electrostatic latent image formed on the electrostatic latent image bearer by using the toner according to embodiments of the present disclosure to form a toner image, a transfer unit that transfers the toner image formed on the electrostatic latent image bearer onto a surface of the recording medium, and a fixing unit that fixes the toner image transferred to the surface of the recording medium, and may optionally further include other units such as a static elimination unit, a cleaning unit, a recycling unit, and a control unit.

The image forming method according to embodiments of the present disclosure includes an electrostatic latent image forming step of forming an electrostatic latent image on the electrostatic latent image bearer, a developing step of developing the electrostatic latent image formed on the electrostatic latent image bearer by using the toner according to embodiments of the present disclosure to form a toner image, a transfer step of transferring the toner image formed on the electrostatic latent image bearer onto a surface of a recording medium, and a fixing step of fixing the toner image transferred onto the surface of the recording medium, and may optionally further include other steps such as a static elimination step, a cleaning step, a recycling step, and a control step.

### Electrostatic Latent Image Forming Step and Electrostatic Latent Image Forming Unit

The electrostatic latent image forming step is a step of forming an electrostatic latent image on the electrostatic latent image bearer.

The electrostatic latent image forming unit is a unit that forms an electrostatic latent image on the electrostatic latent image bearer.

The electrostatic latent image forming step can be suitably implemented by the electrostatic latent image forming unit.

The electrostatic latent image bearer (hereinafter, sometimes referred to as “electrophotographic photoconductor”, “photoconductor”) is not limited for the material, the shape, the structure, and the size thereof and can be appropriately selected from known electrostatic latent image bearers. An example of the shape thereof suitably includes, but is not limited to, a drum form, and examples of the material thereof include, but are not limited to, inorganic photoconductors such as amorphous silicon and selenium, and organic photoconductors such as polysilane and phthalopolymethine.

Examples of the organic photoconductor include, but are not limited to, a laminated photoconductor and a single-layer photoconductor. The laminated photoconductor has a laminated structure in which, on a support body such as an aluminum drum, a layer (charge generation layer) in which a charge generation material such as metal-free phthalocyanine or titanyl phthalocyanine is dispersed in a binder resin, and a layer (charge transport layer) in which a charge transport material is dispersed in a binder resin are laminated. The single-layer photoconductor includes a photosensitive layer having a single layer structure in which both a charge generation material and a charge transport material are dispersed in a binder resin on a support body.

In the single-layer photoconductor, a hole transport agent and an electron transport agent serving as the charge transport material may be added to the photosensitive layer.

Further, an undercoat layer may be provided between a support body and the laminated charge generation layer or between the support body and the single-layer type photosensitive layer.

The electrostatic latent image can be formed, for example, by uniformly charging the surface of the electrostatic latent image bearer and then exposing the surface in the form of an image.

The electrostatic latent image forming unit preferably includes at least a charging unit (charging device) that uniformly charges the surface of the electrostatic latent image bearer, and an exposure unit (exposure device) that exposes the surface of the electrostatic latent image bearer in the form of the image.

The charging can be performed, for example, by using the charging device to apply a voltage to the surface of the electrostatic latent image bearer.

The charging device is not limited and can be appropriately selected according to a purpose. Examples of the charging device include, but are not limited to, known contact charging devices including a conductive or semiconductive roll, a brush, a film, and a rubber blade, and non-contact charging devices utilizing corona discharge such as a corotron and a scorotron.

The charging device is preferably a charging device that is arranged in contact with or not in contact with the electrostatic latent image bearer and charges the surface of the electrostatic latent image bearer by applying DC and AC voltages in a superimposed manner.

The charging device is a charging roller arranged in a non-contact manner close to the electrostatic latent image bearer by using a gap tape and is preferably a charging device that charges the surface of the electrostatic latent image bearer by applying DC and AC voltages in a superimposed manner to a charging roller.

The exposure can be performed, for example, by using the exposure device to expose the surface of the electrostatic latent image bearer in the form of the image.

The exposure device is not limited and can be appropriately selected according to a purpose, as long as the exposure device can expose, in the form of the image to be formed, the surface of the electrostatic latent image bearer charged by the charging device. Examples of the exposure device include, but are not limited to, various types of exposure device such as copying optical systems, rod lens array systems, laser optical systems, and liquid crystal shutter optical systems.

It is noted that in the present disclosure, a back-light method may be adopted in which the electrostatic latent image bearer is exposed to light in the form of an image from the back side.

### Developing Step and Developing Unit

The developing step is a step of developing the electrostatic latent image formed on the electrostatic latent image bearer by using the toner to form a toner image.

The developing unit is a unit that develops the electrostatic latent image formed on the electrostatic latent image bearer by using the toner to form a toner image.

The developing step is suitably performed by the developing unit.

The toner image can be formed, for example, by developing the electrostatic latent image by using the toner.

The developing unit suitably includes at least a developing device that can store the toner and apply the toner to the electrostatic latent image in a contact or non-contact manner, and more preferably includes a developing device including a toner accommodating container.

The developing device may be a monochrome developing device or a multicolor developing device, and a suitable example thereof includes, but is not limited to, a developing device including a stirrer that frictionally stirs the toner to charge the toner and a rotatable magnet roller.

### Transfer Step and Transfer Unit

The transfer step is a step of transferring the toner image formed on the electrostatic latent image bearer onto a surface of a recording medium.

The transfer unit is a unit that transfers the toner image formed on the electrostatic latent image bearer onto a surface of a recording medium.

The transfer step can be suitably implemented by the transfer unit.

The transfer step preferably includes secondarily transferring a toner image onto the recording medium after primarily transferring the toner image on an intermediate transfer body by using the intermediate transfer body, and more preferably includes a primary transfer step of using toners of two or more colors, preferably full-color toners, as the toner, and transferring the toner image onto the intermediate transfer body to form a composite transfer image, and a secondary transfer step of transferring the composite transfer image onto a recording medium.

The transfer unit (the primary transfer unit and the secondary transfer unit) preferably includes at least a transfer device that peels and charges the toner image formed on the electrostatic latent image bearer (photoconductor) onto a side of the recording medium. The number of the transfer unit may be one, or two or more. Examples of the transfer device include, but are not limited to, a corona transfer device using corona discharge, a transfer belt, a transfer roller, a pressure transfer roller, and an adhesive transfer device.

The recording medium is not limited and can be appropriately selected from known recording media (recording sheets).

### Fixing Step and Fixing Unit

The fixing step is a step of fixing a toner image transferred onto a surface of a recording medium.

The fixing unit is a unit that fixes a toner image transferred onto a surface of a recording medium.

The fixing step can be suitably implemented by the fixing unit.

The fixing step may be performed each time a developer of each color is transferred to the recording medium, or may be performed simultaneously for a developer of each color in a superimposed state.

A fixing device serving as the fixing unit is not limited and can be appropriately selected according to a purpose. However, known heating and pressing unit are suitable. Examples of the heating and pressing unit include, but are not limited to, a combination of a heating roller and a pressure roller, and a combination of a heating roller, a pressure roller, and an endless belt.

### Static Elimination Step and Static Elimination Unit

The static elimination step is a step of applying a static elimination bias to the electrostatic latent image bearer to eliminate static electricity.

The static elimination unit is a unit that applies a static elimination bias to the electrostatic latent image bearer to eliminate static electricity.

The static elimination step can be suitably implemented by the static elimination unit.

The static elimination unit is not limited, as long as the static elimination unit can apply a static elimination bias to the electrostatic latent image bearer. The static elimination unit can be appropriately selected from known static elimination devices, and an example of the static elimination unit includes, but is not limited to, a static elimination lamp.

### Cleaning Step and Cleaning Unit

The cleaning step is a step of removing the toner remaining on the electrostatic latent image bearer.

The cleaning unit is a unit that removes the toner remaining on the electrostatic latent image bearer.

The cleaning step can be suitably performed by the cleaning unit.

The cleaning unit is not limited, as long as the cleaning unit can remove the toner remaining on the electrostatic latent image bearer. The cleaning unit can be appropriately selected from known cleaners, and examples of the cleaning unit include, but are not limited to, a magnetic brush cleaner, an electrostatic brush cleaner, a magnetic roller cleaner, a blade cleaner, a brush cleaner, and a web cleaner.

### Recycling Step and Recycling Unit

The recycling step is a step of recycling, in the developing step, the toner removed in the cleaning step.

The recycling unit is a unit that recycles, in the developing unit, the toner removed by the cleaning unit. The recycling unit is not limited, and examples thereof include known conveyance unit.

The recycling step can be suitably implemented by the recycling unit.

### Control Step and Control Unit

The control step is a step of controlling each of the steps.

The control unit is a unit that controls each of the unit.

The control step can be suitably implemented by the control unit.

The control unit is not limited and can be appropriately selected according to a purpose, as long as the control unit can control an operation of each of the unit described above. Examples of the control unit include, but are not limited to, equipment such as a sequencer and a computer.

### (Method of Producing Printed Object)

A method for producing a printed object according to embodiments of the present disclosure includes forming a printed object on a recording medium by using an image forming apparatus including an electrostatic latent image bearer, an electrostatic latent image forming unit that forms an electrostatic latent image on the electrostatic latent image bearer, a developing unit that develops the electrostatic latent image formed on the electrostatic latent image bearer by using the toner to form a toner image, a transfer unit that transfers the toner image formed on the electrostatic latent image bearer onto a surface of the recording medium, and a fixing unit that fixes the toner image transferred on the surface of the recording medium. The method may optionally include other steps.

The printed object includes an image formed using the toner according to embodiments of the present disclosure on the recording medium.

The steps in the method for producing a printed object can use steps similar to the steps in the method for forming an image, and thus, duplicate descriptions will be omitted.

Here, an embodiment of an image forming apparatus according to embodiments of the present disclosure will be described with reference to the drawings. However, the present disclosure is not limited to these embodiments in any way.

It is noted that in the drawings, the same constituent components are denoted by the same reference numerals, and overlapping parts of the description may be omitted. The numbers, positions, shapes, and the like of the following constituent members are not limited to the present embodiment, and may include any numbers, positions, shapes, and the like that are preferable for implementing the present disclosure.

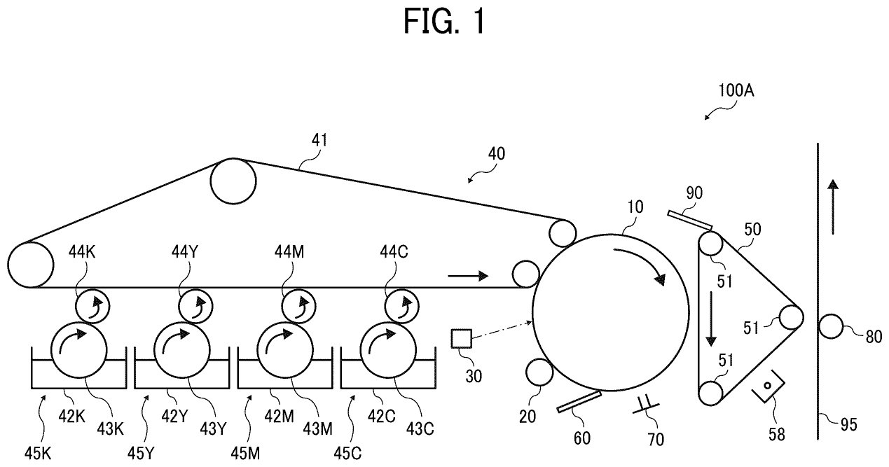

FIG. 1 is a schematic illustrative diagram of an image forming apparatus according to embodiments of the present disclosure.

An image forming apparatus 100A includes a photoconductor drum 10, a charging roller 20, an exposure device 30, a developing device 40, an intermediate transfer belt 50, a cleaning device 60 including a cleaning blade, and a static elimination lamp 70.

The intermediate transfer belt 50 is an endless belt spanning over three rollers 51 arranged within the loop of the intermediate transfer belt 50, and the intermediate transfer belt 50 can move in the direction of an arrow in FIG. 1. Some of the three rollers 51 also function as transfer bias rollers that can apply a transfer bias (primary transfer bias) to the intermediate transfer belt 50. Further, a cleaning device 90 including a cleaning blade is arranged in the vicinity of the intermediate transfer belt 50. A transfer roller 80 that can apply a transfer bias (secondary transfer bias) for transferring a toner image onto a transfer sheet 95, is further arranged to face the intermediate transfer belt 50.

A corona charging device 58 for applying an electric charge to the toner image transferred onto the intermediate transfer belt 50 is arranged between a contact portion of the photoconductor drum 10 and the intermediate transfer belt 50 and a contact portion of the intermediate transfer belt 50 and the transfer sheet 95, with respect to the rotation direction of the intermediate transfer belt 50 around the intermediate transfer belt 50.

The developing device 40 includes a developing belt 41 and a black developing unit 45K, a yellow developing unit 45Y, a magenta developing unit 45M, and a cyan developing unit 45C arranged alongside each other around the developing belt 41. It is noted that the developing units 45K, 45Y, 45M, and 45C of each color respectively include developer storages 42K, 42Y, 42M, and 42C, developer supply rollers 43K, 43Y, 43M, and 43C, and developing rollers (developing agent bearers) 44K, 44Y, 44M, and 44C. The developing belt 41 is an endless belt spanning over a plurality of belt rollers, and can move in the direction of an arrow in FIG. 1. A part of the developing belt 41 is in contact with the photoconductor drum 10.

Next, a method of forming an image by using the image forming apparatus 100A will be described.

First, the surface of the photoconductor drum 10 is uniformly charged by using the charging roller 20, and then, the exposure device 30 is used to expose the photoconductor drum 10 to exposure light L to form an electrostatic latent image. Next, the electrostatic latent image formed on the photoconductor drum 10 is developed with a toner supplied from the developing device 40 to form a toner image. The toner image formed on the photoconductor drum 10 is transferred onto the intermediate transfer belt 50 by the transfer bias applied from the rollers 51 (primary transfer). Subsequently, the toner image is transferred onto the transfer sheet 95 by the transfer bias applied from the transfer roller 80 (secondary transfer). On the other hand, the toner remaining on the surface of the photoconductor drum 10 onto which the toner image is transferred onto the intermediate transfer belt 50 is removed by the cleaning device 60, and then, the electrostatic charge is removed by the static elimination lamp 70.

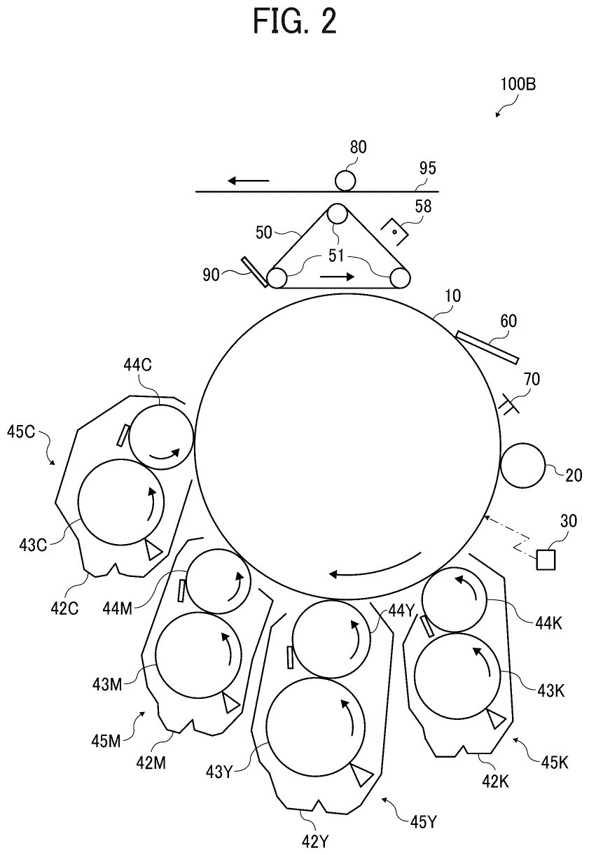

FIG. 2 is a schematic illustrative diagram of another image forming apparatus according to embodiments of the present disclosure.

An image forming apparatus 100B has a similar configuration to the image forming apparatus 100A, except that the developing belt 41 is not provided and the black developing unit 45K, the yellow developing unit 45Y, the magenta developing unit 45M, and the cyan developing unit 45C are arranged around the photoconductor drum 10 to directly face the photoconductor drum 10.

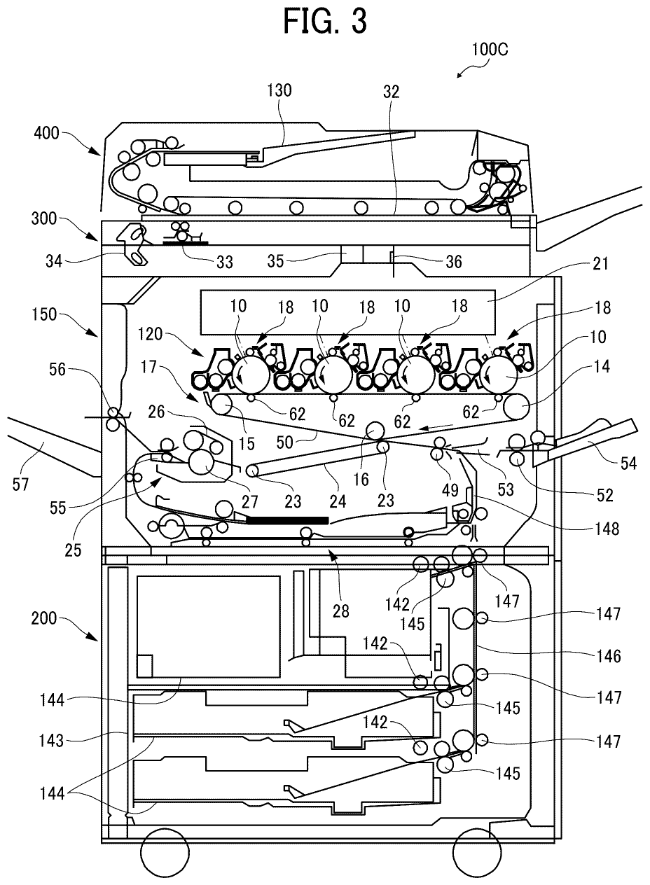

FIG. 3 is a schematic illustrative diagram of another image forming apparatus according to embodiments of the present disclosure.

An image forming apparatus 100C is a tandem-type color image forming apparatus, and includes a copier main body 150, a sheet feeding table 200, a scanner 300, and an automatic document feeder (ADF) 400.

The intermediate transfer belt 50 provided in a center portion of the copier main body 150 is an endless belt spanning over three rollers 14, 15, and 16, and can move in the direction of an arrow in FIG. 3. A cleaning device 17 including a cleaning blade for removing a toner remaining on the intermediate transfer belt 50 from which the toner image is transferred on the recording sheet is arranged in the vicinity of the roller 15. An image forming unit 120 is provided in which image formers 18 for forming yellow, cyan, magenta, and black images are arranged side by side along a conveyance direction and face the intermediate transfer belt 50 spanning over the rollers 14 and 15.

An exposure device 21 is arranged in the vicinity of the image forming unit 120. A secondary transfer belt 24 is further arranged on the side of the intermediate transfer belt 50 opposite to the side where the image forming unit 120 is arranged. It is noted that the secondary transfer belt 24 is an endless belt spanning over a pair of rollers 23, and a recording sheet conveyed on the secondary transfer belt 24 can contact the intermediate transfer belt 50 between the rollers 16 and 23.

In the vicinity of the secondary transfer belt 24, there is further arranged a fixing device 25 including a fixing belt 26, which is an endless belt spanning over a pair of rollers, and a pressure roller 27 arranged to be pressed against the fixing belt 26. It is noted that when an image is to be formed on both sides of the recording sheet, a sheet reversing device 28 for reversing the recording sheet is arranged in the vicinity of the secondary transfer belt 24 and the fixing device 25.

Next, a method of forming a full color image by using the image forming apparatus 100C to will be described.

First, a color document is set on a document stand 130 of the automatic document feeder (ADF) 400. Alternatively, the automatic document feeder 400 is opened, the color document is set on a contact glass 32 of the scanner 300, and the automatic document feeder 400 is closed.

When a start switch is pressed, if the document is set on the automatic document feeder 400, the document is conveyed and moved onto the contact glass 32. On the other hand, if the document is set on the contact glass 32, the scanner 300 is immediately driven, and a first traveling body 33 including a light source and a second traveling body 34 including a mirror travel. At this time, reflected light obtained by reflecting light emitted from the first traveling body 33 by the document surface is reflected by the second traveling body 34, and thereafter, the light is received by a reading sensor 36 via an image forming lens 35. Thus, the document is read, and black, yellow, magenta, and cyan image information is obtained.

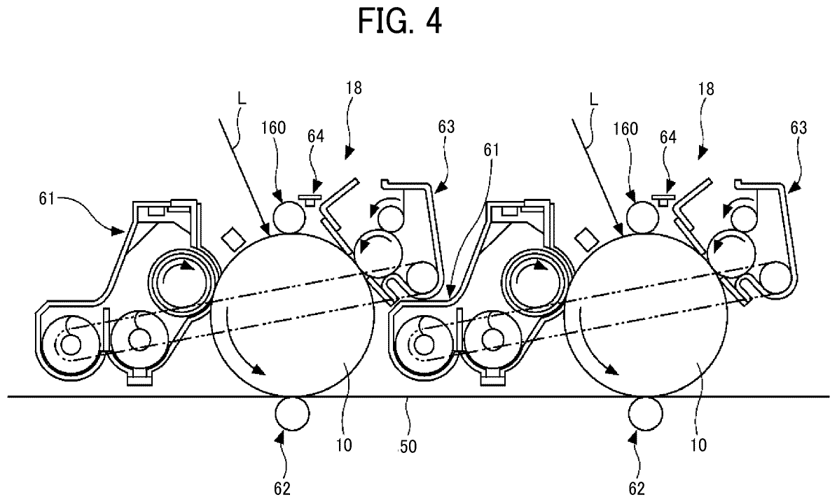

The image information of each color is transmitted to each of the image former 18 in the image forming unit 120 of each color, and a toner image of each color is formed. As illustrated in FIG. 4, the image former 18 of each color each includes the photoconductor drum 10, a charging roller 160 that uniformly charges the photoconductor drum 10, a developing device 61 that develops the electrostatic latent image with a developer of each color to form a toner image of each color, a transfer roller 62 that transfers the toner image onto the intermediate transfer belt 50, a cleaning device 63 including a cleaning blade, and a static elimination lamp 64. The photoconductor drum 10 is exposed to exposure light L based on the image information of each color to form an electrostatic latent image of each color.

The toner images of each color formed by the image formers 18 of each color are sequentially transferred onto the intermediate transfer belt 50 that moves while spanning over the rollers 14, 15, and 16 (primary transfer), and are superimposed to form a composite toner image.

On the other hand, in the sheet feeding table 200, one of sheet feeding rollers 142 is selectively rotated to feed a recording sheet from one of sheet feeding cassettes 144 provided in multiple stages in a paper bank 143, and the recording sheets are separated one by one by a separation roller 145 and transported to a sheet feeding path 146. The recording sheets are conveyed by conveyance rollers 147, guided to a sheet feeding path 148 in the copier main body 150, and stopped by colliding with a registration roller 49. Alternatively, recording sheets on a manual feed tray 54 are fed by rotating a sheet feeding roller, separated one by one by a separation roller 52, guided to a manual sheet feeding path 53, and stopped by colliding with the registration roller 49.

It is noted that the registration roller 49 is generally used while being grounded, but may be used in a state where a bias is applied to remove paper dust from the recording sheets.

Next, by rotating the registration roller 49 at a timing in synchronization with the composite toner image formed on the intermediate transfer belt 50, the recording sheet is transported between the intermediate transfer belt 50 and the secondary transfer belt 24, and the composite toner image is transferred onto the recording sheet (secondary transfer). It is noted that the toner remaining on the intermediate transfer belt 50 to which the composite toner image is transferred is removed by the cleaning device 17.

The recording sheet onto which the composite toner image is transferred is conveyed by the secondary transfer belt 24, and then, the composite toner image is fixed by the fixing device 25. Next, the conveyance path of the recording sheet is switched by a switching claw 55, and the recording sheet is discharged onto a sheet discharge tray 57 by a discharge roller 56. Alternatively, the conveyance path of the recording sheet is switched by the switching claw 55, the recording sheet is reversed by the sheet reversing device 28, and an image is formed in a similar manner on the back side of the recording sheet. Subsequently, the recording sheet is discharged onto the sheet discharge tray 57 by the discharge roller 56.

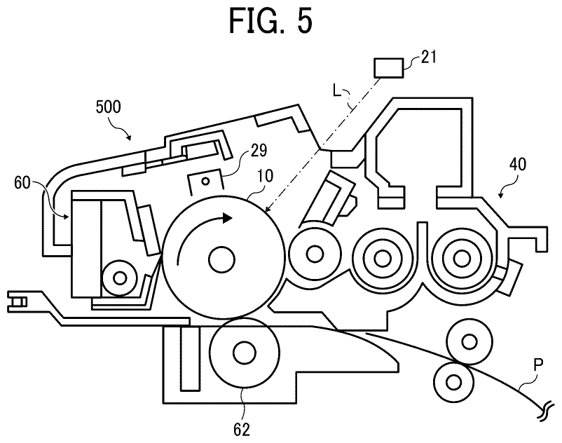

FIG. 5 is a schematic configuration diagram of a process cartridge according to the present embodiment. A process cartridge 500 includes the photoconductor drum 10, a corona charging device 29 serving as a charging unit, the developing device 40, the cleaning device 60, and the transfer roller 62 as illustrated in FIG. 5.

It is noted that in FIG. 5, P indicates a transfer sheet, and L indicates exposure light from the exposure device 21.

With an image forming apparatus and an image forming method according to embodiments of the present disclosure, an image with a high quality can be provided for an extended period of time because the toner according to embodiments of the present disclosure is used that has both excellent fixability at low temperatures and heat-resistant storage stability and that can maintain a good image quality under a high temperature and humidity environment.

### EXAMPLES

The present disclosure will be specifically described below with reference to examples and comparative examples, but the present disclosure is not limited to such examples. It is noted that in the following examples and comparative examples, “parts” refers to “parts by mass”, and “%” refers to “mass %” unless otherwise specified.

### Example 1

### (Preparation of Toner Developer 1)

### <Preparation of Amorphous Polyester Resin>

Monomer species presented in Table 1 below and tetrabutoxy titanate serving as a condensation catalyst were charged into a reaction tank including a cooling tube, a stirrer, and a nitrogen inlet tube, and the mixture was reacted at 230° C. for six hours, while removing the generated water by distillation under a nitrogen stream. Next, the mixture was reacted for one hour under a reduced pressure of 5 mmHg to 20 mmHg, to obtain an amorphous polyester resin. It is noted that in Table 1, “25 mol %” indicated for bisphenol A (2,2) propylene oxide expresses the proportion in the alcohol component when the acid component is 50 mol % and the alcohol component is 50 mol %.

TABLE 1

| Acid component | Alcohol component | OH/COOH |
|---|---|---|
| Terephthalic acid | Bisphenol A (2,2) | 1.1 |
| | propylene oxide (25 mol %) | |
| | Bisphenol A (2,2) | |
| | ethylene oxide (25 mol %) | |

<Preparation of Crystalline polyester Resin>

Fumaric acid and 1,6-hexanediol was charged into a 5 L four-neck flask including a nitrogen inlet tube, a dehydration tube, a stirrer, and a thermocouple so that OH/COOH was 0.9, the mixture was reacted with titanium tetraisopropoxide (500 ppm with respect to the resin components) at 180° C. for 10 hours, and then, the temperature was raised to 200° C. to react for three hours. Next, the mixture was reacted for two hours under a pressure of 8.3 kPa to obtain a crystalline polyester resin.

### <Preparation of Toner Base Particles>

The following materials were premixed by using a Henschel mixer (FM20B, manufactured by Mitsui Miike Kakoki Co., Ltd.), and then melted and kneaded at a temperature of 120° C. by using a twin-screw kneader (PCM-30, manufactured by Ikegai Iron Works Co., Ltd.). Pre-mixing conditions are as follows:

(Pre-mixing conditions)
1600 rpm, 1 min on, 2 min off×8

### (Material)

Amorphous polyester resin: 87.5 parts
Crystalline polyester resin: 4.5 parts
Styrene-α methylstyrene copolymer: 6.0 parts (SA140, manufactured by Kraton, Tg value 87° C.)
Hydrocarbon wax (FNP-0090, manufactured by NIPPON SEIRO CO., LTD.): 3.5 parts
Carbon black (#44, manufactured by Mitsubishi Chemical Corp.): 13 parts
Dispersant: 3 parts

The obtained kneaded product was rolled to a thickness of 2.0 mm by using a roller, and then, cooled to room temperature by using a belt cooler and coarsely ground to a size of 200 μm to 300 μm by using a hammer mill. Subsequently, the obtained product was finely pulverized by using a supersonic jet pulverizer Labojet (manufactured by Nippon Pneumatic Mfg. Co., Ltd.). Afterwards, an air classifier (MDS-I, manufactured by Nippon Pneumatic Mfg. Co., Ltd.) was used to classify the particles while appropriately adjusting the louver opening so that the weight average particle size was 6.8±0.3 μm to obtain toner base particles.

It is noted that although the catalog value for the Tg value of styrene-α-methylstyrene copolymer (SA140, manufactured by Kraton) was 87° C., there was a variation of about ±5° C. depending on the production lot. Therefore, the Tg value was measured in advance by the following measurement method. The same is true for the examples and comparative examples as follows.

### (Method for Measuring Tg Value)

About 5.0 mg of a target sample was charged into a sample container made of aluminum, and thereafter, the sample container was placed on a holder unit and set in an electric furnace. Next, the temperature was increased from −80° C. to 150° C. under a nitrogen atmosphere at the heating rate of 10° C./min and an analysis program in the differential scanning calorimeter was used to determine the glass transition temperature (Tg) of the target sample from the obtained DSC curve. Tg was 83.0° C.

### <Preparation of Toner Developer>

Toner with external additives were prepared by using a Henschel mixer to stir and mix 1 part by mass of HDK-2000 (Clariant Co., Ltd.) as metal oxide fine particles, and 0.6 parts by mass of inorganic coated silica per 100 parts by mass of obtained toner base particles.

5 mass % of the obtained toner with external additives and 95 mass % of coating ferrite carrier were uniformly mixed at 48 rpm for five minutes by using a TURBULA mixer (manufactured by Willy & Bacchofen (WAB) AG) to prepare a toner developer.

### (Method for Measuring S2/S1)

A method for calculating the particle cross-sectional area S1, the total release agent area S2, and the area ratio S2/S1 for 100 toner particles will be described. The calculation method will be explained using a method in which a cross section of a toner particle is observed using a transmission electron microscope.

Examples of the transmission electron microscope include, but are not limited to, LEM-2000 type (manufactured by Topcon Corporation) and JEM-2000FX (manufactured by JEOL Ltd.).

More specifically, the cross section is established according to the following procedure.

First, the toner particles are thoroughly dispersed in a room temperature curing epoxy resin, and then embedded therein, and the epoxy resin is thoroughly cured. A cross section of the toner is prepared using an ultramicrotome (ultrasonic) and optionally stained using ruthenium tetroxide or osmium tetroxide. This is observed with a scanning transmission electron microscope (STEM) and photographed at a magnification of 2000 times or more.

From the obtained cross-sectional images of the toner, the particle cross-sectional area S1, the total release agent area S2, and the area ratio S2/S1 were calculated for 100 toner particles.

For the calculation, an image analysis method using the structure analysis technique of image analysis software “Azokun®” (manufactured by Asahi Kasei Engineering Co., Ltd.) was used.

Specifically, 100 toner cross-sectional images were selected, and the analysis conditions were the number of structures of “3” and the multi-value method of “manual.” The release agent domain region and the aromatic petroleum resin domain region were separated and recognized, and the particle cross-sectional area S1, the total release agent area S2, and the area ratio S2/S1 were calculated for the 100 toner particles from each of the domain areas obtained by separating and recognizing the region.

The average value of S2/S1 for 100 toner particles was calculated and used as the average area ratio.

### (Evaluation of Fixability at Low Temperatures)

The resultant toner developer was placed in a copying machine (RICOH IM C5510) manufactured by Ricoh Co., Ltd., and images were output. A solid image having an adhesion amount of 0.6 mg/cm² was output on paper (Type 6200 manufactured by Ricoh Co., Ltd.) via exposure, development, and transfer steps. The linear speed for fixing was 256 mm/sec. An image was sequentially output with the fixing temperature of 2° C. increments, and the lower limit temperature at which cold offset does not occur (lower limit fixing temperature: fixability at low temperatures) was measured. The fixability at low temperatures was evaluated based on the following evaluation criteria and the results were presented in Table 2.

It is noted that a rating of “Fair” or better was determined to be sufficient for practical use.

### Evaluation Criteria of Fixability at Low Temperatures

Excellent: Less than 120° C.
Good: 120° C. or higher and less than 125° C.
Fair: 125° C. or higher and less than 130° C.
Poor: 130° C. or higher

### Hot Offset Resistance

The developer was placed in a storage unit of a copying machine (RICOH MPC 6003, manufactured by Ricoh Co., Ltd.), and a solid image was formed on a recording medium (Type 6200, manufactured by Ricoh Co., Ltd.) so that the amount of the developer adhered was 0.3 mg/cm². An image was sequentially output with the linear speed for fixing of 256 mm/see, the NIP width of the fixing device of 11 mm, and the fixing temperature with 5° C. increments, the upper limit temperature at which hot offset does not occur (upper limit fixing temperature: hot offset resistance) was measured to evaluate the hot offset resistance based on the following evaluation criteria, and the results were presented in Table 2.

It is noted that a rating of “Fair” or better was determined to be sufficient for practical use.

### Evaluation Criteria of Hot Offset Resistance

Excellent: Upper limit fixing temperature is 200° C. or higher
Good: Upper limit fixing temperature is 190° C. or higher and less than 200° C.
Fair: Upper limit fixing temperature is 180° C. or higher and less than 190° C.
Poor: Upper limit fixing temperature is less than 180° C.

### [HH Filming Evaluation]

The obtained toner developer was placed in a copying machine (RICOH Pro 8420) manufactured by Ricoh Co., Ltd., and a 200,000-sheet run was carried out in a high temperature and humidity environment (30° C., 90%) using a vertical band chart with an image area ratio of 10%, after which the filming state on the photoconductor was visually observed. The filming was evaluated according to the following evaluation criteria and the results are presented in Table 2.

It is noted that a rating of “Fair” or better was determined to be sufficient for practical use.

### Evaluation Criteria of Filming

Excellent: No toner deposits are found on the photoconductor.

Good: Minute toner deposits are found on some parts of the photoconductor, but there is no effect on the image.

Fair: A large amount of toner deposits are found on the photoconductor, but there is no effect on the image.

Poor: A large amount of toner deposits are found on the photoconductor, and an abnormality occurs in the image.

### [Evaluation of Heat-Resistant Storage Stability]

The toner base particles were stored under conditions of 50° C. for 24 hours, and the penetration was measured according to JIS K2235 (25° C.). A penetrometer VR-5610 (Shimadzu Corporation) was used as a penetration measurement device.

### Evaluation Criteria of Heat-Resistant Storage Stability

Excellent: 30.0 mm or more
Good: 25.0 mm or more and less than 30.0 mm
Fair: 20.0 mm or more and less than 25.0 mm
Poor: less than 20.0 mm

It is noted that evaluation results indicated as “excellent” and “good” were determined to be sufficient for practical use.

### Example 2

A toner developer was prepared and evaluated in much the same manner as in Example 1, except that the styrene-α-methylstyrene copolymer (SA140, manufactured by Kraton) was changed to a prototype having a Tg of 80.5° C.

### Example 3

A toner developer was prepared and evaluated in much the same manner as in Example 1, except that the styrene-α-methylstyrene copolymer (SA140, manufactured by Kraton) was changed to a prototype having a Tg of 90° C.

### Example 4

A toner developer was prepared and evaluated in much the same manner as in Example 1, except that the styrene-α-methylstyrene copolymer (SA140, manufactured by Kraton) was changed to a prototype having a Tg of 93.4° C.

### Example 5

A toner developer was prepared and evaluated in much the same manner as in Example 1, except that the hydrocarbon wax (FNP-0090, manufactured by NIPPON SEIRO CO., LTD.) was changed from 3.5 parts to 5.4 parts.

### Example 6

A toner developer was prepared and evaluated in much the same manner as in Example 1, except that the hydrocarbon wax (FNP-0090, manufactured by NIPPON SEIRO CO., LTD.) was changed from 3.5 parts to 2.3 parts.

### Example 7

A toner developer was prepared and evaluated in much the same manner as in Example 1, except that the styrene-α-methylstyrene copolymer (SA140, manufactured by Kraton) was changed to a prototype having the molecular weight MW of about 2,500.

### Example 8

A toner developer was prepared and evaluated in much the same manner as in Example 1, except that the styrene-α-methylstyrene copolymer (SA140, manufactured by Kraton) was changed to a prototype having the molecular weight MW of about 3,800.

### Example 9

A toner developer was prepared and evaluated in much the same manner as in Example 1, except that the styrene-α-methylstyrene copolymer (SA140, manufactured by Kraton) was changed to a prototype having the molecular weight MW of about 2000.

### Example 10

A toner developer was prepared and evaluated in much the same manner as in Example 1, except that the styrene-α-methylstyrene copolymer (SA140, manufactured by Kraton) was changed to a prototype having the molecular weight MW of about 4000.

### Comparative Example 1

A toner developer was prepared and evaluated in much the same manner as in Example 1, except that the styrene-α-methylstyrene copolymer (SA140, manufactured by Kraton) was changed to a partially hydrogenated petroleum resin.

### Comparative Example 2

A toner developer was prepared and evaluated in much the same manner as in Example 1, except that the styrene-α-methylstyrene copolymer (SA140, manufactured by Kraton) was changed to a prototype having Tg of 75.0° C.

### Comparative Example 3

A toner developer was prepared and evaluated in much the same manner as in Example 1, except that the hydrocarbon wax (FNP-0090, manufactured by NIPPON SEIRO CO., LTD.) was changed from 3.5 parts to 6.3 parts.

### Comparative Example 4

A toner developer was prepared and evaluated in much the same manner as in Example 1, except that the hydrocarbon wax (FNP-0090, manufactured by NIPPON SEIRO CO., LTD.) was changed from 3.5 parts to 1.7 parts.

### Comparative Example 5

A toner developer was prepared and evaluated in much the same manner as in Example 1, except that the pre-conditioning conditions were changed to 1800 rpm, 1 min on, and 2 min off X 10, and the hydrocarbon wax (FNP-0090, manufactured by NIPPON SEIRO CO., LTD.) was changed from 3.5 parts to 7.5 parts.

### Comparative Example 6

A toner developer was prepared and evaluated in much the same manner as in Example 1, except that the pre-conditioning conditions were changed to 1800 rpm, 1 min on, and 2 min off X 10, and the hydrocarbon wax (FNP-0090, manufactured by NIPPON SEIRO CO., LTD.) was changed from 3.5 parts to 1.3 parts.

TABLE 2

| | | | | | | Evaluation results | | | |
|---|---|---|---|---|---|---|---|---|---|
| | Aromatic based petroleum resin | | | | Toner | Heat- | | | |
| | | | Molecular | | satisfying | resistant | Fixability | | |
| | | Tg | weight | S2/ | Condition A | storage | at low | Filming | Hot offset |
| | Resin type | [° C.] | (Mw) | S1 | [particles] | stability | temperatures | resistance | resistance |
| Example 1 | Styrene-α-methylstyrene | 83.0 | 3200 | 0.043 | 98 | Excellent | Excellent | Excellent | Excellent |
| | copolymer | | | | | | | | |
| Example 2 | Styrene-α-methylstyrene | 80.5 | 2179 | 0.046 | 97 | Fair | Excellent | Fair | Good |
| | copolymer | | | | | | | | |
| Example 3 | Styrene-α-methylstyrene | 90.0 | 3500 | 0.044 | 96 | Excellent | Good | Good | Excellent |
| | copolymer | | | | | | | | |
| Example 4 | Styrene-α-methylstyrene | 93.4 | 3700 | 0.040 | 97 | Excellent | Fair | Excellent | Excellent |
| | copolymer | | | | | | | | |
| Example 5 | Styrene-α-methylstyrene | 83.6 | 3250 | 0.063 | 91 | Excellent | Good | Fair | Excellent |
| | copolymer | | | | | | | | |
| Example 6 | Styrene-α-methylstyrene | 83.5 | 3300 | 0.028 | 90 | Good | Excellent | Excellent | Fair |
| | copolymer | | | | | | | | |
| Example 7 | Styrene-α-methylstyrene | 81.3 | 2620 | 0.041 | 96 | Fair | Excellent | Good | Good |
| | copolymer | | | | | | | | |
| Example 8 | Styrene-α-methylstyrene | 88.5 | 3700 | 0.047 | 96 | Excellent | Good | Excellent | Good |
| | copolymer | | | | | | | | |
| Example 9 | Styrene-α-methylstyrene | 80.2 | 2310 | 0.045 | 95 | Fair | Good | Fair | Fair |
| | copolymer | | | | | | | | |
| Example 10 | Styrene-α-methylstyrene | 89.5 | 4040 | 0.042 | 94 | Good | Fair | Excellent | Fair |
| | copolymer | | | | | | | | |
| Comp. Example 1 | Partially hydrogenated | 77.0 | 2179 | 0.043 | 90 | Poor | Good | Good | Fair |
| | petroleum resin | | | | | | | | |
| Comp. Example 2 | Styrene-α-methylstyrene | 75.0 | 2500 | 0.045 | 97 | Poor | Good | Good | Poor |
| | copolymer | | | | | | | | |
| Comp. Example 3 | Styrene-α-methylstyrene | 84.2 | 3150 | 0.070 | 84 | Good | Fair | Poor | Good |
| | copolymer | | | | | | | | |
| Comp. Example 4 | Styrene-α-methylstyrene | 84.2 | 3150 | 0.019 | 81 | Fair | Good | Excellent | Poor |
| | copolymer | | | | | | | | |
| Comp. Example 5 | Styrene-α-methylstyrene | 83.8 | 3090 | 0.082 | 90 | Good | Good | Poor | Excellent |
| | copolymer | | | | | | | | |
| Comp. Example 6 | Styrene-α-methylstyrene | 83.8 | 3090 | 0.013 | 91 | Fair | Fair | Good | Poor |
| | copolymer | | | | | | | | |

Aspects of the present disclosure include the following aspects, for example.

### Aspect 1

A toner including toner particles containing a polyester resin, an aromatic petroleum resin, and a release agent, in which
the aromatic petroleum resin has a structure including styrene and α-methylstyrene and has a glass transition temperature of 80° C. or higher, and
the toner satisfies the following conditions A and B when cross sections of 100 toner particles of the toner are observed.

### (Condition A)

When S1 denotes a cross-sectional area of one toner particle and S2 denotes a total cross-sectional area of the release agent in the one toner particle, an average value of S2/S1 satisfies the following relational expression (1).

$$0.015 < S 2 / S 1 < 0.075 \qquad ( 1 )$$

### (Condition B)

90 or more toner particles out of the 100 toner particles satisfy the condition A.

### Aspect 2

The toner according to Aspect 1, in which the aromatic petroleum resin has a glass transition temperature of 80° C. or higher and 90° C. or lower.

### Aspect 3

The toner according to Aspect 1 or Aspect 2, in which the aromatic petroleum resin has a molecular weight of from 2,500 to 3,800.

### Aspect 4

The toner according to any one of Aspect 1 to Aspect 3, in which the release agent includes hydrocarbon wax.

### Aspect 5

A developer including the toner according to any one of Aspect 1 to Aspect 4 and a carrier.

### Aspect 6

A toner storage unit including the toner according to any one of Aspect 1 to Aspect 4 and a container storing the toner.

### Aspect 7

An image forming apparatus including an electrostatic latent image bearer, an electrostatic latent image forming unit to form an electrostatic latent image on the electrostatic latent image bearer, a developing unit to develop the electrostatic latent image formed on the electrostatic latent image bearer with a toner to form a toner image, and a transfer unit to transfer the toner image onto a transfer body, in which the toner is the toner according to any one of Aspect 1 to Aspect 4.

### Aspect 8

An image forming method including charging an electrostatic latent image bearer, forming an electrostatic latent image on the electrostatic latent image bearer charged, developing the electrostatic latent image with a toner to form a toner image, transferring the toner image onto a transfer body, cleaning a surface of the electrostatic latent image bearer by a cleaning device after the transferring, and fixing the toner image, in which the toner is the toner according to any one of Aspect 1 to Aspect 4.

### Aspect 9

The image forming method according to Aspect 8, further including recycling the toner collected from the surface of the electrostatic latent image bearer in the cleaning for the developing.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A toner comprising:
toner particles containing:
a polyester resin;
an aromatic petroleum resin having a structure including styrene and α-methylstyrene and having a glass transition temperature of 80° C. or higher; and
a release agent,
wherein the toner satisfies the following conditions A and B when cross sections of 100 toner particles of the toner are observed:
Condition A: when S1 denotes a cross-sectional area of one toner particle and S2 denotes a total cross-sectional area of the release agent in the one toner particle, an average value of S2/S1 satisfies the following relational expression (1):
$$0.015 < S 2 / S 1 < 0.075 ; \qquad ( 1 )$$
Condition B: 90 or more toner particles out of the 100 toner particles satisfy the condition A.

2. The toner according to claim 1, wherein the aromatic petroleum resin has a glass transition temperature of 80° C. or higher and 90° C. or lower.

3. The toner according to claim 1, wherein the aromatic petroleum resin has a molecular weight of from 2,500 to 3,800.

4. The toner according to claim 1, wherein the release agent includes a hydrocarbon wax.

5. A developer comprising:
the toner according to claim 1; and
a carrier.

6. A toner storage unit comprising:
the toner according to claim 1; and
a container storing the toner.

7. An image forming apparatus comprising:
an electrostatic latent image bearer;
an electrostatic latent image forming unit to form an electrostatic latent image on the electrostatic latent image bearer;
a developing unit to develop the electrostatic latent image formed on the electrostatic latent image bearer with the toner according to claim 1 to form a toner image; and
a transfer unit to transfer the toner image onto a transfer body.

8. An image forming method comprising:
charging an electrostatic latent image bearer;
forming an electrostatic latent image on the electrostatic latent image bearer charged;
developing the electrostatic latent image with the toner according to claim 1 to form a toner image;
transferring the toner image onto a transfer body;
cleaning a surface of the electrostatic latent image bearer by a cleaning device after the transferring; and
fixing the toner image.

9. The image forming method according to claim 8, further comprising:
recycling the toner collected from the surface of the electrostatic latent image bearer in the cleaning for the developing.
